(19) United States
(12) Patent Application Publication
(10) Pub. No.: US 2018/0285937 A1
(43) Pub. Date: Oct. 4, 2018

(54) CONTENT ITEM CONFIGURATION EVALUATION

(71) Applicant: Google Inc., Mountain View, CA (US)

(72) Inventor: Patrick Hummel, Cupertino, CA (US)

(73) Assignee: Google Inc., Mountain View, CA (US)

(21) Appl. No.: 14/160,633

(22) Filed: Jan. 22, 2014

(51) Int. Cl. G06Q 30/02

(52) U.S. Cl. CPC G06Q 30/0275

(57) ABSTRACT

Methods, systems, and apparatus, including computer programs encoded on a computer storage medium, for evaluating content item configurations are disclosed. In one aspect, a method includes receiving a request for content items to be presented in at least some of two or more presentation positions of a resource. Position factors are obtained for two or more different content item configurations. Based at least in part on the position factors, a preferred content item configuration is selected. A determination is made that the position factor for a particular presentation position increases as the number of presentation positions increases. In response to the determination that the position factor increases, a reserve price is determined for each available presentation position. A number of content items that will be provided is determined based on a number of the reserve prices that are met by bids associated with content items.

### BACKGROUND

This specification relates to data processing and content distribution.

The Internet facilitates the exchange of information and transactions between users across the globe. This exchange of information enables content sponsors to provide sponsored content to a variety of users. A content sponsor can control the distribution of their content items (e.g., promotions, advertisements, audio files, video files, or other content items) based on a set of distribution parameters that specify under what conditions a content item is eligible to be distributed. When a presentation opportunity meeting the conditions is available, the content item provided by a content sponsor is deemed eligible to be provided for presentation.

### SUMMARY

In general, one innovative aspect of the subject matter described in this specification can be embodied in methods that include the actions of receiving a request for one or more content items to be presented in at least some of two or more presentation positions of a resource; obtaining, for presentation positions of two or more different content item configurations, position factors that are based on a performance of content items presented in the presentation positions; determining, based at least in part on the position factors, that a first content item configuration is associated with a higher expected configuration efficiency than a second content item configuration that has fewer presentation positions than the first content item configuration; determining that a position factor for a particular presentation position in the first content item configuration is higher than a second position factor for the particular presentation position in the second content item configuration; determining, for each particular presentation position in the first content item configuration, a reserve price based on an expected value of other presentation positions in the first content item configuration and the position factor for the particular presentation position; determining that the reserve price for a presentation position in the first content item configuration is not met by a bid associated with a candidate content item that is eligible for presentation in the presentation position; and providing, in response to the request, a candidate content item for presentation in each presentation position of the second content item configuration. Other embodiments of this aspect include corresponding systems, apparatus, and computer programs, configured to perform the actions of the methods, encoded on computer storage devices.

These and other embodiments can each optionally include one or more of the following features. Methods can include the actions of determining a first expected configuration efficiency for the first content item configuration based on one or more bids associated with a first set of content items eligible for presentation in a set of first presentation positions of the first content item configuration and one or more first position factors for the first set of presentation positions; and determining a second expected configuration efficiency for the second content item configuration based on one or more bids associated with a second set of content items eligible for presentation in a second set of presentation positions of the second content item configuration and one or more second position factors for the second set of presentation positions.

Determining a reserve price for each particular presentation position in the first content item configuration can include determining a value of a first particular presentation position based on a bid associated with a content item selected for presentation in the first particular presentation position and the position factor for the first particular presentation position; determining a ratio of the value of the first particular presentation position and the position factor for a second particular presentation position; and determining the reserve price for the second presentation position based on the ratio and a maximum specified deviation from the higher expected configuration efficiency. Determining a value of a first particular presentation position can include determining the value of a first presentation position that is included in each of the first content item configuration and the second content item configuration.

Methods can include the actions of determining, for each particular presentation position in a third content item configuration, a reserve price based on an expected value of other presentation positions in the third content item configuration and the position factor for the particular presentation position. Methods can include the actions of determining that a reserve price for a particular presentation position in the third content item configuration is not met by a bid associated with content items eligible for presentation in the third content item configuration, wherein the third content item configuration includes more presentation positions than the second content item configuration.

Methods can include the actions of receiving, for each content item provided for presentation in the second content item configuration, performance data specifying whether a user interacted with the content item; and updating the position factor for each presentation position in the second content item configuration based on the received performance data.

Particular embodiments of the subject matter described in this specification can be implemented so as to realize one or more of the following advantages. Providing fewer than the particular number of content items that are associated with a highest efficiency facilitates collection of performance data for various content item configurations for which data may not have otherwise been collected. Collecting performance data for the various content item configurations can result in more accurate position factors for different content item slots of a resource than those position factors that would be determined without the collected performance data. Using the more accurate position factors to select the number of content items provided can result in realization of higher revenue for a particular resource than would have been realized without the more accurate position factors.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content is distributed to user devices.

FIG. 2 is an example data flow illustrating selection of a content item configuration.

FIG. 3 is a flow chart of an example process for selecting a content item configuration.

FIG. 4 is an illustration of an example web page.

FIG. 5 is a block diagram of an example computer system.

Like reference numbers and designations in the various drawings indicate like elements.

### DETAILED DESCRIPTION

This document describes apparatus, systems, methods, and computer readable medium related to determining a number of content items (e.g., advertisements) to be provided in response to a content item request (e.g., advertisement request). In some implementations, the number of content items to be provided in response to a request is determined, based at least in part, on an amount of revenue (or value) that is expected to be generated when different numbers of content items are provided in response to the content item request. For brevity, the amount of revenue (or value) that is expected to be generated by a particular number of content items is referred to as an expected configuration efficiency. As discussed in detail below, expected configuration efficiencies for the various numbers of content items that can be provided in response to a particular content item request can be compared to select, for example, the number of content items that is associated with the highest expected configuration efficiency, which is referred to as a preferred configuration. In turn, the corresponding number of content items can be provided in response to the content item request.

The expected configuration efficiencies are generally determined, based in part, on historical content item performance (e.g., a historical click-through-rate), and in some situations the historical content item performance may not accurately reflect future content item performance. For example, if a statistically significant amount of historical content item performance has not been acquired for a particular resource (and/or one or more different numbers of presented content items), a particular number of content items (e.g., a highest number of content items that can be presented with the resource) may be associated with a highest expected configuration efficiency, while a different number of content items (e.g., fewer than the highest number of content items) may result in a highest actual configuration efficiency for that resource.

As described in more detail below, content item selection techniques can provide fewer than the particular number of content items that is associated with a preferred configuration upon a determination that one or more conditions are met. In some implementations, the conditions can require, at least in part, that an expected loss (e.g., revenue loss or value loss) that will result from providing fewer than the particular number of content items in the preferred configuration is less than a specified amount in order for the fewer number of content items to be provided. The conditions can include other requirements, as discussed below.

The following description refers to selection and distribution of advertisements, which are a type of content item. The description that follows is also applicable to other types of content items. For example, video files, audio files, or other content items can be distributed using the techniques described below.

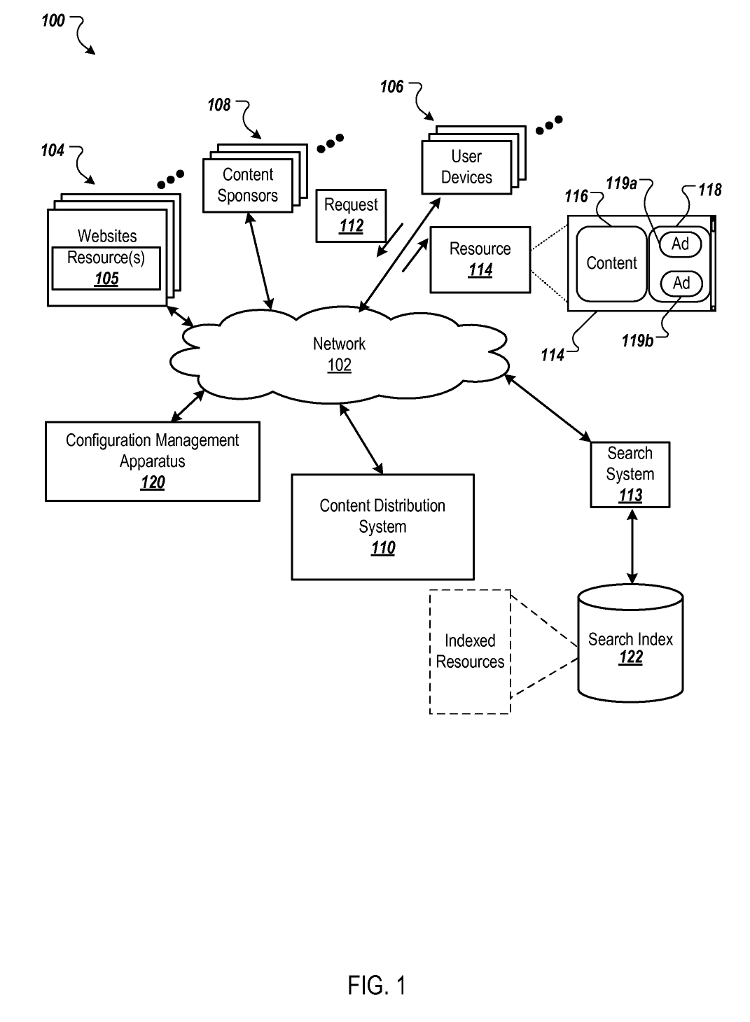

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, content sponsors 108, and a content distribution system 110. The example environment 100 may include many different websites 104, user devices 106, and content sponsors 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items, and an individual content item can be stored in a single file or set of files independent of the resource.

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104, a web page from a social network, or another resource 105. The data representing the requested resource 114 can include data that cause presentation of resource content 116 at the user device 106. The data representing the requested resource 114 can also include data specifying a content item slot 118. A content item slot is a portion of the resource (e.g., a portion of a web page) or a portion of a user display (e.g., a presentation location of another window or in a slot of a web page) in which one or more content items, such as advertisements, can be presented. A content items slot 118 can also be referred to as an advertisement slot, but any type of content (e.g., content items other than advertisements) can be presented in the content item slot 118.

A single content item slot 118 may be configured to include one or more presentation positions 119a and 119b. Alternatively or additionally, each different content item slot 118 can be considered a separate presentation position. Each presentation position can represent a portion of the content item slot 118 at which a content item can be presented. In some implementations, the number of presentation positions and/or the size of the presentation positions for a particular content item slot 118 may be determined based on the number, type, and/or value of content items that are available for presentation in the content item slot. For example, as described in detail below, a set of content items that are associated with respective highest values (e.g., among eligible content items) may be selected for presentation, and the number of presentation positions included in the content item slot 118 can be determined based on the number of content items that are included in the selected set of content items. A publisher can specify a maximum number of presentation positions that are to be included in a particular content item slot, and the selection of the set of content items can be constrained based on that maximum number.

To facilitate searching of resources, the environment 100 can include a search system 113 that identifies the resources by crawling and indexing the resources provided by the publishers on the websites 104. Data about the resources can be indexed based on the resource with which the data are associated. The indexed and, optionally, cached copies of the resources are stored in a search index 122. Data that are associated with a resource is data that represents content included in the resource and/or metadata for the resource.

User devices 106 can submit search queries to the search system 113 over the network 102. In response, the search system 113 accesses the search index 122 to identify resources that are relevant to the search query. The search system 113 identifies the resources in the form of search results and returns the search results to the user device in search results page. A search result is data generated by the search system 113 that identifies a resource that is responsive to a particular search query, and includes a link to the resource. An example search result can include a web page title, a snippet of text or a portion of an image extracted from the web page, and the URL of the web page. Like other resources, search results pages can include one or more content item slots 118 in which content items, such as advertisements, can be presented.

When a resource 105 is requested by a user device 106, execution of code associated with a content item slot 118 in the resource initiates a request for one or more content items to populate the slot. The request can include characteristics of the slots that are defined for the requested resource 114. For example, a reference (e.g., URL) to the requested resource 114 for which the content item slot 118 is defined, a size of the content item slot, a maximum number of presentation positions (or content items) that can be included in the content item slot 118, and/or media types that are eligible for presentation in the content item slot 118 can be provided to the content distribution system 110. Similarly, keywords associated with a requested resource (“resource keywords”) or entities that are referenced by the resource can also be provided to the content distribution system 110 to facilitate identification of content items that are relevant to the requested resource 114. The requests can also include other information, such as information that the user has provided, geographic information indicating a state or region from which the request was submitted, or other information that provides context for the environment in which the content item will be displayed (e.g., a type of device at which the content item will be displayed, such as a mobile device or tablet device).

The content items that are provided in response to a request (or another content item request) are selected based, in part, on distribution parameters associated with the content items. Distribution parameters are a set of criteria upon which distribution of content items are conditioned. In some implementations, the distribution criteria for a particular content item can include distribution keywords that must be matched (e.g., by resource keywords or search queries) in order for the content item to be eligible for presentation. The distribution criteria can also specify a bid and/or budget for distributing the particular content item. As described in more detail below, bids can be used to select a set of content items for presentation with a resource and/or to determine in which presentation position the content item(s) will be presented.

In some implementations, the content distribution system 110, either alone or in combination with one or more data processing apparatus, determines a number of content items that will be provided in response to a particular content item request. For example, if the content distribution system 110 receives a request for one or more content items, the request may specify, or be associated with, a maximum number of content items that are able to be presented in a particular content item slot. In response to the content item request, the content distribution system 110 determines a number of content items, up to the maximum number, that will be provided in response to the request. For example, if the content item request specifies that up to five content items can be presented in a particular content item slot, the content distribution system can select between zero and five content items to be provided in response to the content item request.

In some implementations, the content items selected by the content distribution system 110 are sized for presentation based on the total number of content items that are being provided in response to the request 112. For example, assume that the dimensions of the content item slot 118 remain constant irrespective of the number of content items that are presented in the content item slot 118. In this example, the selected content items can be sized so that the total dimensions of the combined set of content items correspond to (e.g., equal or be some specified amount less than) the dimensions of the content items slot 118, and the size of each content item can correspond to, or determine, a size of a presentation position for the content item. Thus, when a single content item is presented, that content item can have dimensions equal to the dimensions of the content item slot 118. Similarly, when two content items are presented, each of the content items can be sized to occupy one-half of the content item slot 118, and the dimensions of the content items can continue to decrease as the number of content items presented in the content item slot 118 increases. Note that for purposes of example, the content items are each assumed to occupy an equal portion (when two or more are presented) of the content item slot 118, but the techniques described in this document can also be used when the various content items are of various sizes (e.g., where a highest ranked content item occupies more space than a lower ranked content item).

The performance of content items can vary based on the size of the content items and/or a number of content items that are presented. For example, if only a single content item is presented in a content item slot 118, that content item will be presented more prominently than if another content item were presented in the content item slot 118 with that content item. Similarly, when a single content item is selected, that content item will be the only content item in the slot with which a user can interact. As more content items are presented in the content item slot 118, the user has the option of selecting any of the content items presented in the content item slot 118. Therefore, the expected performance of a particular content item when presented with one or more other content items may be lower than the expected performance when the particular content item is the only content item presented in the content item slot 118.

The performance of a content item can also vary based, in part, on a presentation position of the content item within the content item slot 118. For example, assume that two content items are presented in two presentation positions 119a and 119b of the content item slot 118. In this example, users may more often interact with content items that are presented in a particular presentation position (e.g., a more prominent presentation position 119a), such that the performance of (e.g., a number of clicks received by) content items presented in the particular presentation position may generally be higher than the performance of content items presented in the other presentation position (e.g., 119b).

In a particular example, the presentation position 119a may have a higher historical performance (e.g., historical click through rate) than the presentation position 119b. Therefore, the expected performance of a particular content item when selected for presentation in presentation position 119a may be higher than the expected performance of that same content item when selected for presentation in presentation position 119b. Differences in expected performance of a content item based on the presentation position in which the content item is presented and/or a number of other content items that are being presented with the content item can be quantified using position factors, which are discussed in more detail below.

In some implementations, the number of content items that are selected for presentation in the content item slot 118 can be based on an expected configuration efficiency associated with each different number of content items that can be presented in the content item slot 118. For example, in response to the request 112, the content distribution system 110 can determine an expected configuration efficiency associated with providing only one content item for presentation in the content item slot, and another expected configuration efficiency associated with providing two content items for presentation in the content item slot 118.

The configuration efficiency for a particular number of content items is generally based, at least in part, on an expected revenue (or value) that is associated with presentation of that number of content items. In some implementations, the expected revenue (or value) that is associated with presentation of a particular number of content items can be determined based on a bid corresponding to each content item that will be presented in each presentation position and the position factor corresponding to the presentation positions in which the content items will be presented. The expected configuration efficiency for each different number of content items can be determined, for example, using a relationship similar to relationship (1).

$$Efficiency ( x ) = {\sum }_{i = 1}^{x} {b}_{i} * {pf}_{i} \qquad ( 1 )$$

where,

Efficiency(x) is the efficiency associated with a configuration (x) in which (x) content items are presented;

bᵢ is the bid associated with a content item eligible to be presented in presentation position (i); and

pfᵢ is the position factor for presentation position (i).

In a particular example, assume that an estimated cost per mille (eCPM) bid associated with a first content item is $20, and that the eCPM bid for a second content item is $10. For purposes of this example, further assume that the position factor for presentation position 119a is 0.4 (e.g., corresponding to a click-through-rate of 0.4) when only one content item is presented in the content item slot 118, and the position factor for presentation position 119a is 0.2 (e.g., corresponding to a click-through-rate of 0.2) when content items are presented in presentation position 119a and presentation position 119b. Further assume that the position factor for presentation position 119b is 0.1 (e.g., corresponding to a click-through-rate of 0.1) when content items are presented in presentation positions 119a and 119b. In this example and using relationship (1), the expected configuration efficiency corresponding to presentation of a single content item can be 8.0 (i.e., 20*0.4) and the expected configuration efficiency corresponding to presentation of two content items can be 5.0 (i.e., 20*0.2+10*0.1).

In this example, the contribution to the expected configuration efficiency of the content item presented in presentation position 119a (i.e., the content item associated with the $20 bid) decreases from 8.0 when only that content item is presented to 4.0 when the content item associated with the $10 bid is presented in presentation position 119b. Also, in this example, the contribution to the expected configuration efficiency of the content item presented in presentation position 119b (i.e., the content item associated with the $10 bid, which is 10*0.1) is not high enough to overcome the reduction from 8.0 to 4.0 of the contribution by the content item presented in presentation position 119a. Thus, in this example, only one content item will be provided for presentation in the presentation position 119a.

As illustrated by this example, a single presentation position can have a different position factor for each different configuration in which the presentation position is available for presentation. For instance, in the example above presentation position 119a has a first position factor of 0.4 for a first configuration in which only a single content item is presented in the content item slot 118, and a second different position factor of 0.2 for a second configuration in which content items are presented in both of presentation position 119a and presentation position 119b.

For each particular configuration, the position factor for a particular presentation position can be determined based, at least in part, on the historical performance of content items presented in that presentation position and in that particular configuration. Thus, in some implementations, only performance data collected for that particular configuration will be used to determine the position factor for presentation positions in that particular configuration. As such, the accuracy of position factors for a particular configuration can depend on the amount and/or accuracy of the performance data that has been collected for that particular configuration. That is, if less than a statistically significant amount of performance data has been collected for a particular configuration and/or the collected performance data are skewed or inaccurate for some reason, the performance factors for that particular configuration may not be accurate, which may result in expected configuration efficiency values that are not accurate for that particular configuration.

Using inaccurate position factors may result in a less efficient number of content items (e.g., a maximum number of content items) being presented in response to a content item request when a different number of content items (e.g., fewer than the maximum number of content items) may actually lead to a higher efficiency. For example, assume that when the resource 114 was initially made available an initial set of performance data resulted in an initial position factor of 0.2 for presentation position 119a when only one content item is presented in the content item slot 118, an initial position factor of 0.22 for presentation position 119a when a content item is presented in each of the presentation positions 119a and 119b, and an initial position factor of 0.05 for the presentation position 119b when a content item is presented in each of the presentation positions 119a and 119b.

Continuing with this example, the expected configuration efficiency for presentation position 119a, when no other content items are presented in other available presentation positions (e.g., 119b), can be 4.0 (i.e., 20*0.2). The expected configuration efficiency when content items are presented in each of presentation position 119a and presentation position 119b can be 4.9 (i.e., 20*0.22+10*0.05). In this example, the expected configuration efficiency for the two content item configuration (i.e., 4.9) is greater than the expected configuration efficiency for the one content item configuration (i.e., 4.0), so the content distribution system 110 will generally select two content items for presentation in the presentation positions 119a and 119b.

Assuming that the position factor for the two content item configuration does not change based on newly received performance data, the two content item configuration will continue to be selected by the content distribution system 110 because the expected configuration efficiency associated with the two content item configuration will continue to be higher than that for the one content item configuration. As such, it is possible that no new performance data will be collected for the one content item configuration, and the position factor for the one content item configuration will not be updated even though the collection of additional performance data for the one content item configuration may lead to a significantly higher position factor for presentation position 119a in the one content item configuration.

To facilitate collection of performance data for various content item configurations, the environment includes a Configuration Management Apparatus (“CMA”) 120. The CMA 120 is one or more data processing apparatus that determine whether a content item configuration associated with a highest expected configuration efficiency should be used, or whether a different content item configuration should be used (e.g., to collect additional data about the different content item configuration). As discussed in more detail below, the CMA 120 can determine which content item requests are eligible for use of a different content item configuration (e.g., a content item configuration that is not associated with a highest expected configuration efficiency), for example, based on the position factors of the available content item configurations.

In some implementations, the CMA 120 can limit the use of a content item configuration that is not associated with a highest expected configuration efficiency to situations in which a position factor for a particular presentation position increases as the number of content items presented increases. Continuing with the last example above, the position factor for presentation position 119a is 0.2 when only one content item is presented in presentation position 119a and increases to 0.22 when a content item is presented in each of presentation position 119a and presentation position 119b. While a position factor for a particular presentation position can increase when an additional content item is presented in an additional content item slot, such an increase in position factors may be an indication that the position factor for that presentation position is inaccurate. Therefore, the CMA 120 can use such an increase in the position factor as a condition for evaluating whether to use a content item configuration other than that associated with the highest expected configuration efficiency. For brevity and clarity, the phrase “preferred configuration” will be used to refer to a content item configuration that is associated with a highest expected configuration efficiency, and the phrase “non-preferred configuration” will be used to refer to a content item configuration that is not associated with a highest expected configuration efficiency.

Once the CMA 120 has determined to evaluate one or more non-preferred configurations for possible use (e.g., based on the increase in a position factor for a particular presentation position as the number of content items increases), the CMA 120 can determine whether to use one of the non-preferred configurations based, at least in part, on a difference between the expected configuration efficiency for the non-preferred configuration and the expected configuration efficiency for the preferred configuration efficiency. For example, if the difference is lower than a specified amount (e.g., percentage) the non-preferred configuration can be used instead of the preferred configuration. Other conditions (e.g., conditions based on bids associated with the content items) can also be required to be met, and will be discussed in detail below.

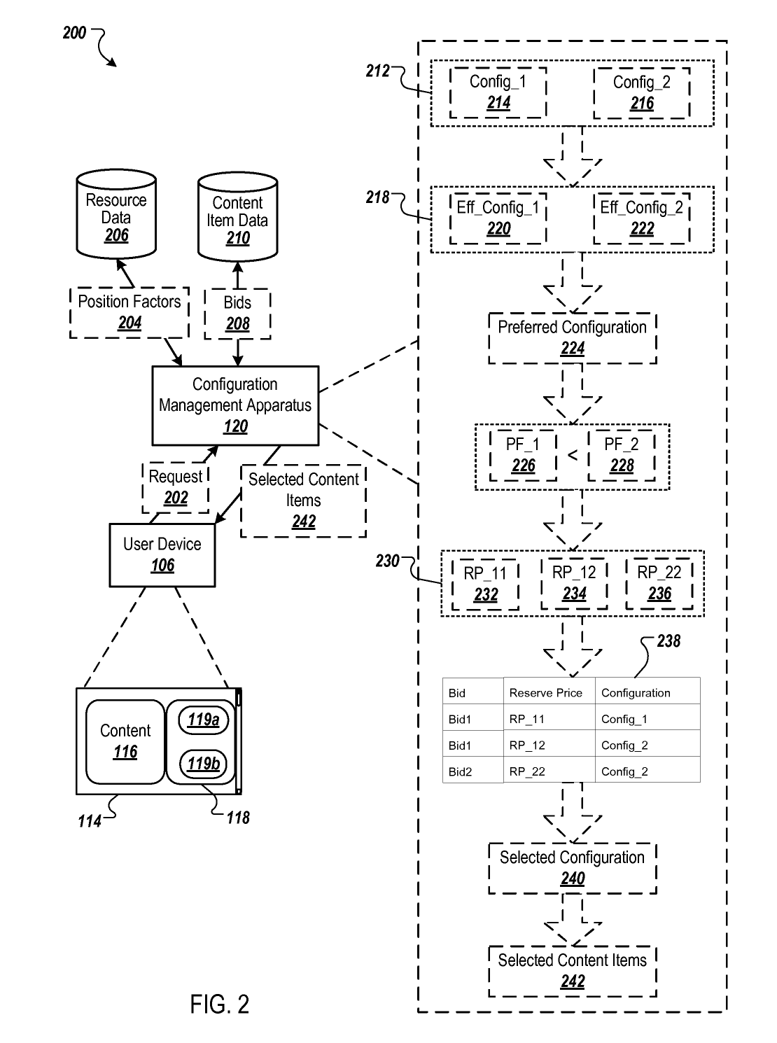

FIG. 2 is an example data flow 200 illustrating selection of a content item configuration. The data flow 200 begins with the CMA 120 receiving a content item request 202. The content item request 202 is a request for a content item (e.g., advertisement) that will be presented with a resource (e.g., web page). For example, as illustrated by FIG. 2, the content item request 202 (“request”) can be submitted by a user device 106 when the resource 114 is rendered at the user device 106. For example, execution of code included in the resource 114 can cause the user device 106 to submit the content item request 202.

The CMA 120 can receive the content item request 202 directly from the user device 106 or from another device or system (e.g., the content distribution system 110). For example, if the CMA 120 is implemented independent of the content distribution system 110, the user device 106 may submit the content item request 202 to the content distribution system 110, which can provide the content item request 202 (or data associated with the content item request 202) to the CMA 120.

The content item request 202 can include data specifying a number of content items that can be presented with the resource 114. For example, as illustrated by FIG. 2, the resource 114 includes a content item slot 118 having two presentation positions 119a and 119b. In this example, the content item request 202 may specify that up to two content items can be presented with the resource 114 (e.g., in presentation positions 119a and 119b).

In response to receiving the content item request 202 (or data associated with the content item request 202), the CMA 120 obtains position factors 204 for the presentation positions 119a and 119b that are included in the resource 114. The position factors 204 can be obtained, for example, from a data store such as the resource data store 206, which stores data related to resources to which content items are provided.

The position factor for each presentation position is a value based, at least in part, on historical performance of content items that have been presented in the presentation position. For example, the position factor for presentation position 119a can be determined based on a click-through-rate (or another performance measure) of content items that have been presented in the presentation position 119a, and the position factor for presentation position 119b can be determined based on a click-through-rate of content items that have been presented in the presentation position 119b. The position factor for each presentation position is generally an indication of the likelihood that a user will interact with (e.g., click) a content item presented in that presentation position.

In response to receiving the content item request 202, the CMA 120 can also obtain bids 208 associated with content items that are eligible for presentation in the presentation positions 119a and 119b. The bids 208 can be received, for example, from a content item data store 210 that stores data for multiple different content items. The bids specify, for each content item, an amount that a content sponsor will pay for distribution of the content item.

The CMA 120 identifies, based on the information included in the content item request 202, a set of candidate content item configurations 212. The set of candidate content item configurations 212 specifies one or more content item configurations that can be used to present content items with the resource. Each content item configuration can specify a number of presentation positions that are included in the content item configuration and/or locations of the presentation positions. For example, using information regarding the presentation positions 119a and 119b, the CMA 120 can identify two candidate content item configurations 214 (“Config_1”) and 216 (“Config_2”). Config_1 214 can be, for example, a content item configuration in which a content item is only presented in the presentation position 119a, and can be referred to as a one content item configuration. Config_2 216 can be, for example, a content item configuration in which a content item is presented in each of presentation position 119a and presentation position 119b, and can be referred to as a two content item configuration.

Using the bids 208 and the position factors 204, the CMA 120 determines a set of expected configuration efficiencies 218 for the set of content item configurations 212. For example, the CMA 120 can determine the expected configuration efficiency (e.g., Eff_Config_1 220) of Config_1 214 using a bid associated with a content item that would be presented in presentation position 119a (assuming Config_1 214 was used) and the position factor for presentation position 119a in Config_1 214. Similarly, the CMA 120 can determine the expected configuration efficiency (e.g., Eff_Config_2 222) of Config_2 216 using bids associated with the content items that would be presented in the presentation positions 119a and 119b (assuming Config_2 216 was used) and the position factors for the presentation positions 119a and 119b in Config_2 216. In some implementations, Eff_Config_1 220 and Eff_Config_2 222 can be determined using relationship (1) discussed above.

The CMA 120 selects a preferred configuration 224 based on the set of configuration efficiencies 218. In some implementations, the CMA 120 selects, as the preferred configuration 224, the configuration associated with the highest expected configuration efficiency. For purposes of the examples that follow, it is assumed that Config_2 216 (the two content item configuration in which content items are presented in presentation positions 119a and 119b) is selected as the preferred configuration 224.

The CMA 120 compares different position factors for a particular presentation position to determine whether a non-preferred configuration (e.g., a content item configuration other than that selected as the preferred configuration 224) is eligible to be used instead of the preferred configuration 224. In some implementations, a non-preferred configuration is eligible to be used when a position factor for a particular presentation position increases as the number of presentation positions increases. For example, assume that a three content item configuration was selected as the preferred configuration, and that a particular presentation position is included in each of a two content item configuration and the three content item configuration. Further assume that the position factor for the particular presentation position in the two content item configuration is lower than the position factor for the particular presentation position in the three content item configuration. In this example, a non-preferred configuration is eligible to be used because the position factor for the particular presentation position increases as the number of presentation positions increases.

In the present example, the set of candidate configurations 212 includes only a one content item configuration (i.e., Config_1 214) and a two content item configuration (i.e., Config_2 216), and the only presentation position that is included in each of the content item configurations is presentation position 119a. Thus, in this example, the determination of whether a non-preferred configuration is eligible for use is based on whether the position factor for the presentation position 119a increases from the one content item configuration (i.e., Config_1 214) to the two content item configuration (i.e., Config_2 216). For purposes of example, it will be assumed that the CMA 120 determines that position factor PF_1 226 for presentation position 119a in the one content item configuration (i.e., Config_1 214) is lower than the position factor PF_2 228 for presentation position 119a in the two content item configuration (i.e., Config_2 216).

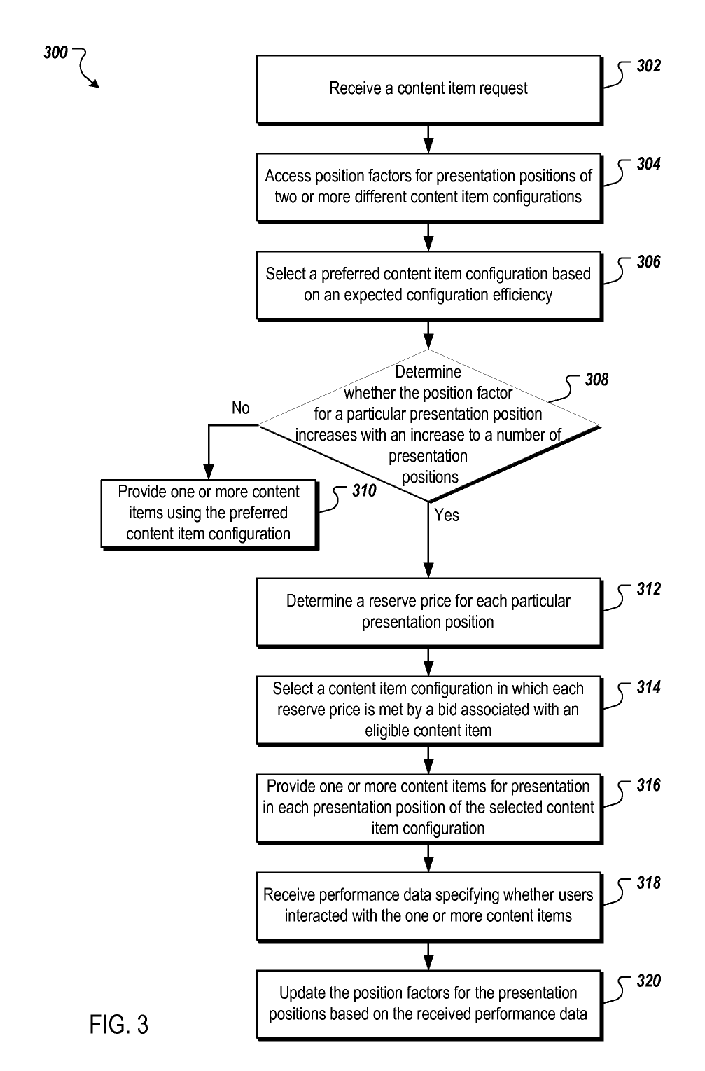

In response to determining that a non-preferred configuration is eligible to be used, the CMA 120 computes a set of reserve prices 230 for the presentation positions. Each reserve price is a minimum bid that must be associated with a content item in order for the content item to be eligible for presentation in the presentation position corresponding to the reserve price. For example, in Config_1 214, the reserve price RP_11 232 is the minimum bid that must be associated with a content item in order for the content item to be presented in the presentation position 119a, which is the only presentation position in Config_1 214. Similarly, in Config_2 216, the reserve price RP_12 234 is the minimum bid that must be associated with a content item in order for the content item to be presented in the presentation position 119a, and RP_22 236 is the minimum bid that must be associated with a content item in order for the content item to be presented in the presentation position 119b. The computation of reserve prices is discussed in more detail below with reference to FIG. 3.

The CMA 120 determines whether to use the non-preferred configuration for the request 202 based on the bids 208 and the set of reserve prices 230. In some implementations, the determination of whether to use the non-preferred configuration is based on whether the bids 208 meet the reserve prices for the presentation positions 119a and 119b in each of the content item configurations. For example, as illustrated by table 238 in FIG. 2, the CMA 120 can compare the bid associated with the content items that are eligible for presentation in the presentation positions 119a and 119b to the reserve prices 232, 234, and 236 that have been determined by the CMA 120. For purposes of example, it is assumed that Bid1 meets the reserve price RP_11 and that Bid2 does not meet RP_22. In this example, the non-preferred configuration Config_1 214 will be identified as the Selected Configuration 240 for the request 202 because Config_1 214 is the configuration for which the bids associated with the eligible content items met the reserve price for each presentation position in the content item configuration.

The CMA 120 identifies the content items having the bids that meet the reserve prices of the selected configuration 240 as selected content items 242 to be provided in response to the request 202. In turn, the CMA 120 (or the content distribution system 110) provides the selected content items 242 to the user device 106 (either directly or through one or more other data processing apparatus).

FIG. 3 is a flow chart of an example process 300 for selecting a content item configuration. The process 300 can be performed by one or more data processing apparatus, such as the CMA 120 and/or content distribution system 110 of FIG. 1. Operations of the process 300 can be implemented by instructions that when executed cause one or more data processing apparatus to perform operations of the process 300. The instructions can be stored on a non-transitory computer readable medium.

A content item request is received (302). In some implementations, the content item request is a request for one or more content items to be presented in at least some of two or more presentation positions of a resource. As discussed above with reference to FIG. 1, a content item can include multiple presentation positions. The content item request can include information specifying the number of presentation positions, which can correspond to a maximum number of content items that can be presented in a single page view and/or provided in response to the request.

In some implementations, the content item request includes data with which different available content item configurations corresponding to the request can be identified. For example, the content item request can include data specifying the available content item configurations, or data in the content item request can be used to obtain data from a data store that stores available content item configuration information for various resources.

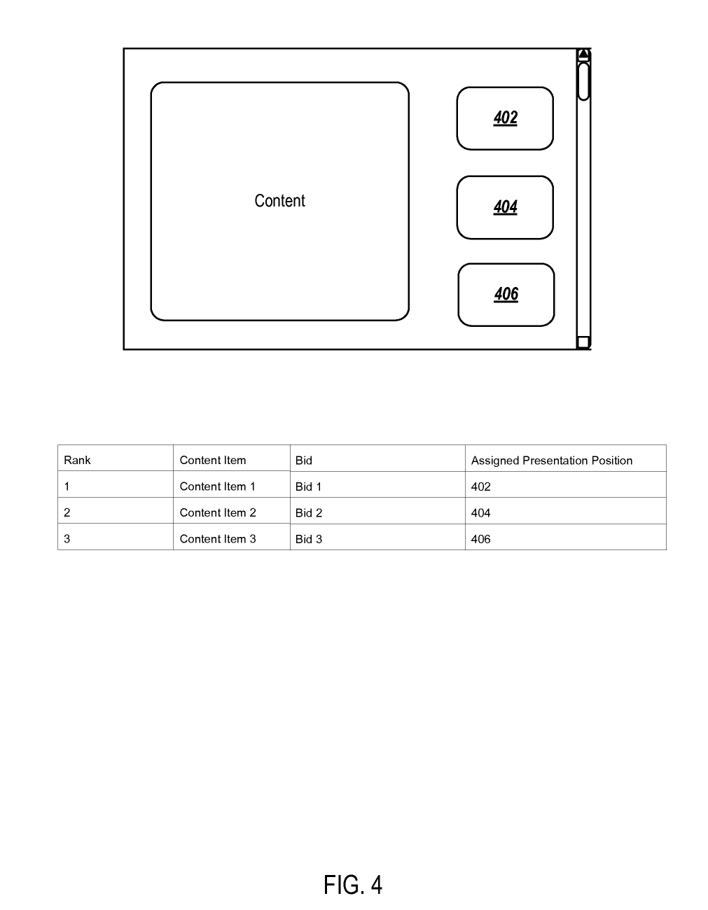

In some implementations, the available content item configurations can include from one presentation position to the maximum number of presentation positions specified by the content item request. For example, assume that the content item request specifies that there are three presentation positions available for presenting content items. In this example, the available content item configurations can include a first content item configuration that has one presentation position (e.g., presentation position 402 of FIG. 4), a second content item configuration that has two presentation positions (e.g., presentation positions 402 and 404 of FIG. 4), and a third content item configuration that has three presentation positions (e.g., presentation positions 402, 404, and 406 of FIG. 4).

Position factors are accessed for presentation positions of two or more different content item configurations (304). In some implementations, the position factor for each presentation position is based on a performance of content items that were previously presented in the presentation positions. For example, as discussed above, the position factor for a particular presentation position can be based on a click-through-rate of content items (e.g., advertisements) that were previously presented in the particular presentation position.

A particular presentation position can be associated with multiple different position factors. For example, a particular presentation position can have a different position factor corresponding to each different content item configuration in which the presentation position is presented. For instance, in the example above, three presentation positions provide at least three different content item configurations. Continuing with that example, a first presentation position that is included in the first content item configuration can also be included in the second content item configuration and the third content item configuration. Thus, the first presentation position can have one position factor corresponding to the first content item configuration, another position factor corresponding to the second content item configuration, and still another different position factor corresponding to the third content item configuration. Similarly, a second presentation position that is included in both the second content item configuration and the third content item configuration can have a different position factor for each of those content item configurations.

A preferred content item configuration is selected based on an expected configuration efficiency (306). In some implementations, the preferred content item configuration is selected based on a determination that a particular available content item configuration is associated with a higher expected configuration efficiency than the other available content item configurations.

Continuing with the example above, an expected configuration efficiency can be determined for each of the first content item configuration, the second content item configuration, and the third content item configuration. For example, the expected configuration efficiency for each content item configuration can be determined using relationship (1), bids corresponding to content items that are eligible for presentation in the presentation positions of the content item configuration, and the position factors corresponding to the presentation positions in the content item configuration. For purposes of examples that follow, it will be assumed that the third content item configuration (i.e., the content item configuration having three presentation positions) is selected as the preferred content item configuration.

A determination is made whether the position factor for a particular presentation position increases as a number of presentation positions increases (308). The determination can be based, for example, on a comparison of the different position factors for each presentation position that is included in two or more different content item configurations. Continuing with the example above, the position factors for the first presentation position (e.g., presentation position 402 in FIG. 4) can be compared to determine whether the position factor corresponding to the first content item configuration (i.e., the content item configuration having one presentation position) is lower than either of the position factors corresponding to the first presentation position (e.g., presentation position 402 of FIG. 4) in either of the second content item configuration (i.e., the content item configuration having two presentation positions) or the third content item configuration (i.e., the content item configuration having three presentation positions). Similarly, for the second presentation position (e.g., presentation position 404 of FIG. 4), a determination can be made whether the position factor corresponding to the second content item configuration (i.e., the content item configuration having two presentation positions) is smaller than the position factor for the second presentation position (e.g., presentation position 404 of FIG. 4) in the third content item configuration (i.e., the content item configuration having three presentation positions). A similar determination can be made for any other content item configurations and/or presentation positions.

When it is determined that the position factor for none of the presentation positions increases with an increase to the number of presentation positions, one or more content items are provided using the preferred content item configuration (310).

When it is determined that the position factor for a particular presentation position increases as the number of presentation positions increases, a reserve price is determined for each particular presentation position in the preferred configuration (312). In some implementations, the reserve price for each particular presentation position in the preferred configuration can be determined based on an expected value of other presentation positions in the preferred configuration and the position factor for the particular presentation position for which the reserve price is being determined. For example, relationship (2) can be used to compute the reserve price for each presentation position (j) of configuration (x).

$${R}_{j} = \frac{y}{100 - y} * ( \frac{Efficiency ( x ) - {b}_{j} * {pf}_{j}}{{pf}_{j}} ) \qquad ( 2 )$$

where,

Rⱼ is the reserve price for presentation position (j) of configuration (x) that includes (x) presentation positions;

y is a maximum amount of expected loss that is acceptable in order to use a non-preferred content item configuration;

Efficiency(x) is the efficiency associated with a configuration (x) as provided above in relationship (1);

bⱼ is the bid associated with a content item eligible to be presented in presentation position (j); and

pfⱼ is the position factor for presentation position (j).

An administrator of the process 300 (e.g., an administrator of the content distribution system 110 and/or the configuration management apparatus 120) can select the value of (y) to be used in relationship (2). For example, a particular administrator may be willing to accept a higher amount of loss (e.g., 10%) on various content item requests in order to collect the performance data for a non-preferred content item configuration, whereas another administrator of a different system may be willing to accept less loss (e.g., 5%) in order to obtain the performance data.

In some implementations, the bid (bᵢ) corresponding to each presentation position can be identified from a ranked set of bids for the content items. For example, as illustrated by FIG. 4, Bid 1, Bid 2, and Bid 3 can be ranked in descending order of bid value, and the presentation positions 402, 404, and 406 can be assigned to a particular rank position. In this example, the bid corresponding to each presentation position will be the bid at the rank position to which the presentation position is assigned. For example, a highest (or most prominent) presentation position (e.g., 402) may be assigned to the highest rank position (e.g., Rank 1), such that the highest ranked bid (e.g., Bid 1) corresponds to the highest presentation position.

For purposes of illustration, assume that reserve price is being determined for a second presentation position (e.g., 404) in a two content item configuration. In the example of a two content item configuration, the reserve price for the second presentation position (e.g., a presentation position that is not included in the one content item configuration) can include determining the value of a first presentation position (e.g., 402) that is included in the two content item configuration (e.g., a configuration that includes only presentation position 402 and presentation position 404). The value can be determined, for example, based on a bid corresponding to the first presentation position (e.g., Bid 1) and the position factor for the first presentation position (e.g., the position factor for presentation position 402). For example, the value can be determined as the result of b₁*pf₁, where b₁ is the bid corresponding to the first presentation position and pf₁ is the position factor for the first presentation position.

Continuing with this example, a ratio of the value of the first presentation position (e.g., 402) and the position factor for the second presentation position (e.g., 404) can be determined. For example, the ratio can be the result of b₁*pf₁/pf₂, where pf₂ is the position factor for the second presentation position (e.g., the position factor for presentation position 404). Additionally, the ratio can be multiplied by a loss factor (e.g., y/100−y) to arrive at the reserve price for the second presentation position. As noted above, y represents a maximum loss that is acceptable for using a non-preferred content item configuration. For example, y can represent a maximum acceptable deviation from the expected configuration efficiency.

In this example, the determination of the reserve price for the second presentation position (e.g., 404) can be represented by relationship (3)

$${R}_{2} = \frac{y}{100 - y} * ( \frac{{b}_{1} {pf}_{1}}{{pf}_{2}} ) \qquad ( 3 )$$

where,

R₂ is the reserve price for the second presentation position (j) of a two content item configuration;

y is a maximum amount of expected loss that is acceptable in order to use a non-preferred content item configuration;

b₁ is the bid associated with a content item eligible to be presented in the first presentation position;

pf₁ is the position factor for the first presentation position; and

pf₂ is the position factor for the second presentation position.

Returning to the example of a three content item configuration (e.g., a content item configuration that includes presentation position 402, presentation position 404, and presentation position 406), the reserve price for the second presentation position (e.g., 404) can be represented by relationship (4).

$${R}_{2} = \frac{y}{100 - y} * ( \frac{{b}_{1} {pf}_{1} + {b}_{3} {pf}_{3}}{{pf}_{2}} ) \qquad ( 4 )$$

where,

R₂ is the reserve price for the second presentation position (j) of a three content item configuration;

y is a maximum amount of expected loss that is acceptable in order to use a non-preferred content item configuration;

b₁ is the bid associated with a content item eligible to be presented in the first presentation position;

pf₁ is the position factor for the first presentation position;

b₃ is the bid associated with a content item eligible to be presented in the third presentation position;

pf₃ is the position factor for the third presentation position and

pf₂ is the position factor for the second presentation position.

Similarly, the determination of a reserve price for the third presentation position (e.g., 406) in the three content item configuration can be represented by relationship (5).

$${R}_{3} = \frac{y}{100 - y} * ( \frac{{b}_{1} {pf}_{1} + {b}_{2} {pf}_{2}}{{pf}_{3}} ) \qquad ( 5 )$$

where,

R₃ is the reserve price for the second presentation position (j) of a two content item configuration;

y is a maximum amount of expected loss that is acceptable in order to use a non-preferred content item configuration;

b₁ is the bid associated with a content item eligible to be presented in the first presentation position;

pf₁ is the position factor for the first presentation position;

b₂ is the bid associated with a content item eligible to be presented in the second presentation position;

pf₂ is the position factor for the second presentation position and

pf₃ is the position factor for the third presentation position.

Here, the determination of the reserve price for the third presentation position in the three content item configuration is based, in part, on a ratio of a sum of the values of the first presentation position (e.g., 402) and the second presentation position (e.g., 404) relative to the position factor for the third presentation position (e.g., the position factor for presentation position 406).

A content item configuration in which each reserve price is met by a bid associated with an eligible content item is selected (314). In some implementations, the selection of a content item configuration comprises determining a number of content items that will be provided in response to the content item request. For example, assume that a three content item configuration was selected as the preferred content item configuration. In this example, the selection of a content item configuration can include selecting whether one, two, or three content items will be presented in the three available presentation positions (e.g., 402, 404, and 406).

The selection of a content item configuration can be based, for example, on the reserve prices that are met by the bids (e.g., Bid 1, Bid 2, and Bid 3) associated with the content items (e.g., Content Item 1, Content Item 2, and Content Item 3) that were selected for presentation in the preferred content item configuration. Continuing with the example above, assume that Content Item 1, Content Item 2, and Content item 3 were selected for presentation in the preferred content item configuration, and that Bid 1, Bid 2, and Bid 3 each respectively meet the reserve prices for presentation position 402, 404, and 406. In this example, it can be determined that all three content items will be provided in response to the content item request.

If, however, Bid 3 does not meet the reserve price for presentation position 406, leaving only Bid 2 and Bid 1 as respectively meeting the reserve prices for presentation positions 404 and 402, then it can be determined that only two content items will be provided in response to the content item request. If both Bid 2 and Bid 3 fail to respectively meet the reserve prices for presentation positions 404 and 406, while Bid 1 meets the reserve price for presentation position 402, then it can be determined that only one content item (e.g., Content Item 1) will be provided in response to the content item request.

One or more content items are provided for presentation in each presentation position of the selected content item configuration (316). In some implementations, the content items corresponding to the bids that meet the reserve prices for their corresponding presentation positions are provided in response to the content item request.

Performance data specifying whether users interacted with the one or more content items are received (318). For example, data can be received indicating whether a user clicked one of the content items that were provided in response to the request. This data can be stored in a performance data store that stores performance data for content items and/or stored in the resource data store 206 of FIG. 2.

The position factors for the presentation positions are updated based on the received performance data (320). In some implementations, the position factors can be adjusted, for example, based on the performance data. For example, the position factor for a particular presentation position can be increased in response to receipt of performance data representing an increase in the click-through-rate for content items presented in the particular presentation position (e.g., relative to the historical click-through-rate for content items presented in the particular presentation position).

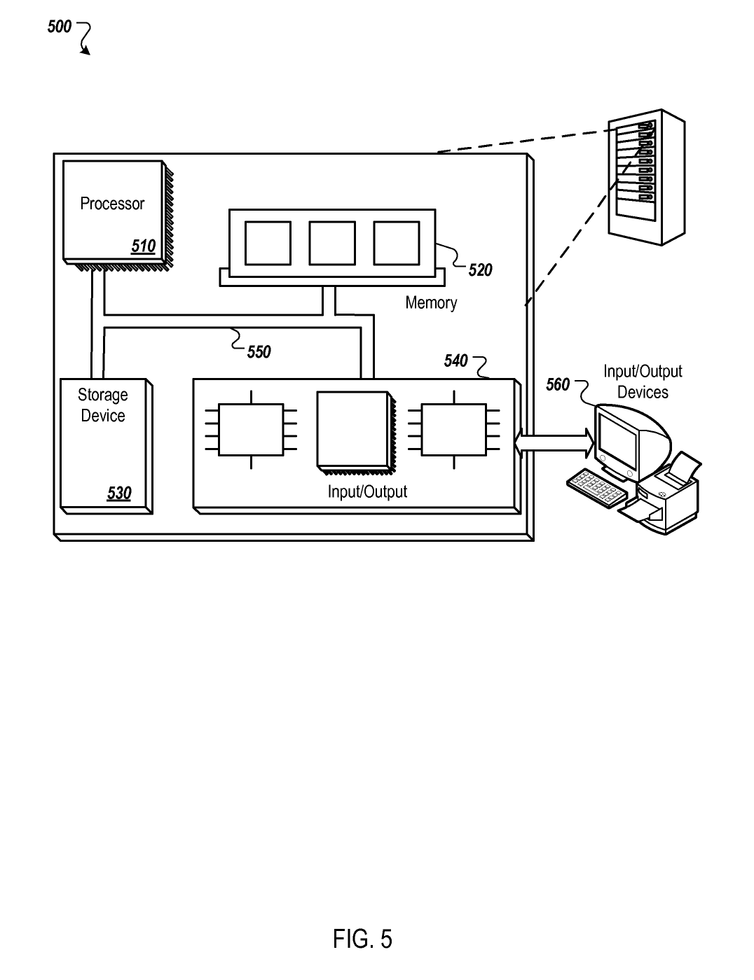

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit),

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a request for one or more content items to be presented in at least some of two or more presentation positions of a same resource;
obtaining, by one or more data processing apparatus and for each presentation position of two or more different content item configurations of presentation positions on the same resource, a position factor that represents a relative performance of content items that (i) were previously presented in the presentation position of the same resource, and (ii) are no longer presented in the presentation position of the same resource;
determining, by one or more data processing apparatus and based at least in part on the position factors, that a first content item configuration has a higher expected configuration efficiency than a second content item configuration that has fewer presentation positions than the first content item configuration, wherein the first content item configuration is preferred over the second content item configuration because the first content item configuration has a higher expected configuration efficiency;
determining that a position factor for a particular presentation position on the same resource increases as a number of presentation positions on the same resource increases, including determining, by one or more data processing apparatus, that a position factor for the particular presentation position in the first, preferred content item configuration is higher than a second position factor for the particular presentation position in the second content item configuration that has fewer presentation positions than the first content item configuration;
determining, because of the determination that a position factor for a particular presentation position on the same resource increases as the number of presentation positions on the same resource increases, by one or more data processing apparatus and for each particular presentation position in the first content item configuration, a reserve price based on (i) an expected value of other presentation positions in the first content item configuration and (ii) the position factor for the particular presentation position;
determining, by one or more data processing apparatus, that the reserve price for a given presentation position in the first, preferred content item configuration on the same resource is not met by an unaltered bid value for a candidate content item in a set of content items that are eligible for presentation in the given presentation position in the first, preferred content item configuration; and
in response to determining that the reserve price is not met by the bid associated with the candidate content item that is eligible for presentation in the presentation position in the first, preferred content item configuration on the same resource, providing for presentation in each presentation position of the second content item configuration on the same resource, by one or more data processing apparatus and in response to the request, a candidate content item from the set of content items that are eligible for presentation in the given presentation position in the first, preferred content item configuration that i) meets a respective reserve price for the second content item configuration, and ii) does not meet the reserve price for the given presentation position in the first, preferred content item configuration, for presentation in each presentation position of the second content item configuration instead of the first, preferred content item configuration that has the higher expected configuration efficiency than the second content item configuration.

2. The method of claim 1, further comprising:
determining a first expected configuration efficiency for the first content item configuration based on a weighted sum of one or more bids associated with a first set of content items eligible for presentation in a set of first presentation positions of the first content item configuration and one or more first position factors for the first set of presentation positions; and
determining a second expected configuration efficiency for the second content item configuration based on a weighted sum of one or more bids associated with a second set of content items eligible for presentation in a second set of presentation positions of the second content item configuration and one or more second position factors for the second set of presentation positions,
wherein the position factor for the first particular presentation position represents a likelihood that a user will click on a content item in the first particular presentation position, and
wherein the request for one or more content items to be presented in at least some of two or more presentation positions of a same resource specifies a particular number of content items to be presented at the same resource.

3. The method of claim 1, wherein determining a reserve price for each particular presentation position in the first content item configuration comprises:
determining a value of a first particular presentation position based on a bid associated with a content item selected for presentation in the first particular presentation position and the position factor for the first particular presentation position;
determining a ratio of the value of the first particular presentation position and the position factor for a second particular presentation position; and
determining the reserve price for the second presentation position based on the ratio and a maximum specified deviation from the higher expected configuration efficiency.

4. The method of claim 3, wherein determining a value of a first particular presentation position comprises determining the value of a first presentation position that is included in each of the first content item configuration and the second content item configuration.

5. The method of claim 1, further comprising determining, for each particular presentation position in a third content item configuration, a reserve price based on an expected value of other presentation positions in the third content item configuration and the position factor for the particular presentation position.

6. The method of claim 5, further comprising determining that a reserve price for a particular presentation position in the third content item configuration is not met by a bid associated with content items eligible for presentation in the third content item configuration, wherein the third content item configuration includes more presentation positions than the second content item configuration.

7. The method of claim 1, further comprising:
receiving, for each content item provided for presentation in the second content item configuration, performance data specifying whether a user interacted with the content item; and
updating the position factor for each presentation position in the second content item configuration based on the received performance data.

8. A non-transitory computer storage medium encoded with a computer program, the program comprising instructions that when executed by one or more data processing apparatus cause the one or more data processing apparatus to perform operations comprising:
receiving a request for one or more content items to be presented in at least some of two or more presentation positions of a same resource;
obtaining, for each presentation position of two or more different content item configurations of presentation positions on the same resource, a position factor that represents a relative performance of content items that (i) were previously presented in the presentation position of the same resource, and (ii) are no longer presented in the presentation position of the same resource;
determining, based at least in part on the position factors, that a first content item configuration has a higher expected configuration efficiency than a second content item configuration that has fewer presentation positions than the first content item configuration, wherein the first content item configuration is preferred over the second content item configuration because the first content item configuration has a higher expected configuration efficiency;
determining that a position factor for a particular presentation position on the same resource increases as a number of presentation positions on the same resource increases, including determining, by one or more data processing apparatus, that a position factor for the particular presentation position in the first, preferred content item configuration is higher than a second position factor for the particular presentation position in the second content item configuration that has fewer presentation positions than the first content item configuration;
determining, because of the determination that a position factor for a particular presentation position on the same resource increases as the number of presentation positions on the same resource increases, for each particular presentation position in the first content item configuration, a reserve price based on (i) an expected value of other presentation positions in the first content item configuration and (ii) the position factor for the particular presentation position;
determining that the reserve price for a given presentation position in the first, preferred content item configuration on the same resource is not met by an unaltered bid value for a candidate content item in a set of content items that are eligible for presentation in the given presentation position in the first, preferred content item configuration; and
in response to determining that the reserve price is not met by the bid associated with the candidate content item that is eligible for presentation in the presentation position in the first, preferred content item configuration on the same resource, providing for presentation in each presentation position of the second content item configuration on the same resource, in response to the request, a candidate content item from the set of content items that are eligible for presentation in the given presentation position in the first, preferred content item configuration that i) meets a respective reserve price for the second content item configuration, and ii) does not meet the reserve price for the given presentation position in the first, preferred content item configuration, for presentation in each presentation position of the second content item configuration instead of the first, preferred content item configuration that has the higher expected configuration efficiency than the second content item configuration.

9. The computer storage medium of claim 8, wherein the instructions cause the one or more data processing apparatus to perform operations further comprising:
determining a first expected configuration efficiency for the first content item configuration based on one or more bids associated with a first set of content items eligible for presentation in a set of first presentation positions of the first content item configuration and one or more first position factors for the first set of presentation positions; and
determining a second expected configuration efficiency for the second content item configuration based on one or more bids associated with a second set of content items eligible for presentation in a second set of presentation positions of the second content item configuration and one or more second position factors for the second set of presentation positions.

10. The computer storage medium of claim 8, wherein determining a reserve price for each particular presentation position in the first content item configuration comprises:
determining a value of a first particular presentation position based on a bid associated with a content item selected for presentation in the first particular presentation position and the position factor for the first particular presentation position;
determining a ratio of the value of the first particular presentation position and the position factor for a second particular presentation position; and
determining the reserve price for the second presentation position based on the ratio and a maximum specified deviation from the higher expected configuration efficiency.

11. The computer storage medium of claim 10, wherein determining a value of a first particular presentation position comprises determining the value of a first presentation position that is included in each of the first content item configuration and the second content item configuration.

12. The computer storage medium of claim 8, wherein the instructions cause the one or more data processing apparatus to perform operations further comprising determining, for each particular presentation position in a third content item configuration, a reserve price based on an expected value of other presentation positions in the third content item configuration and the position factor for the particular presentation position.

13. The computer storage medium of claim 12, wherein the instructions cause the one or more data processing apparatus to perform operations further comprising determining that a reserve price for a particular presentation position in the third content item configuration is not met by a bid associated with content items eligible for presentation in the third content item configuration, wherein the third content item configuration includes more presentation positions than the second content item configuration.

14. The computer storage medium of claim 8, wherein the instructions cause the one or more data processing apparatus to perform operations further comprising:
receiving, for each content item provided for presentation in the second content item configuration, performance data specifying whether a user interacted with the content item; and
updating the position factor for each presentation position in the second content item configuration based on the received performance data.

15. A system comprising:
a data store storing, for a plurality of presentation positions, position factors that represent a relative performance of content items that were previously presented in the presentation positions of the same resource; and
one or more data processing apparatus that interact with the data store and execute instructions that cause the one or more data processing apparatus to perform operations comprising:
receiving a request for one or more content items to be presented in at least some of two or more presentation positions of a same resource;
obtaining, for each presentation position of two or more different content item configurations of presentation positions on the same resource, a position factor that represents a relative performance of content items that (i) were previously presented in the presentation position of the same resource, and (ii) are no longer presented in the presentation position of the same resource;
determining, based at least in part on the position factors, that a first content item configuration has a higher expected configuration efficiency than a second content item configuration that has fewer presentation positions than the first content item configuration, wherein the first content item configuration is preferred over the second content item configuration because the first content item configuration has a higher expected configuration efficiency;
determining that a position factor for a particular presentation position on the same resource increases as a number of presentation positions on the same resource increases, including determining that the position factor for a particular presentation position in the first, preferred content item configuration is higher than a second position factor for the particular presentation position in the second content item configuration that has fewer presentation positions than the first content item configuration;
determining, because of the determination that a position factor for a particular presentation position on the same resource increases as the number of presentation positions on the same resource increases, for each particular presentation position in the first content item configuration, a reserve price based on (i) an expected value of other presentation positions in the first content item configuration and (ii) the position factor for the particular presentation position;
determining that the reserve price for a given presentation position in the first, preferred content item configuration on the same resource is not met by an unaltered bid value for a candidate content item in a set of content items that are eligible for presentation in the given presentation position in the first, preferred content item configuration; and
in response to determining that the reserve price is not met by the bid associated with the candidate content item that is eligible for presentation in the presentation position in the first, preferred content item configuration on the same resource, providing for presentation in each presentation position of the second content item configuration on the same resource, in response to the request, a candidate content item from the set of content items that are eligible for presentation in the given presentation position in the first, preferred content item configuration that i) meets a respective reserve price for the second content item configuration, and ii) does not meet the reserve price for the given presentation position in the first, preferred content item configuration, for presentation in each presentation position of the second content item configuration instead of the first, preferred content item configuration that has the higher expected configuration efficiency than the second content item configuration.

16. The system of claim 15, wherein the instructions cause the one or more data processing apparatus to perform operations further comprising:
determining a first expected configuration efficiency for the first content item configuration based on one or more bids associated with a first set of content items eligible for presentation in a set of first presentation positions of the first content item configuration and one or more first position factors for the first set of presentation positions; and
determining a second expected configuration efficiency for the second content item configuration based on one or more bids associated with a second set of content items eligible for presentation in a second set of presentation positions of the second content item configuration and one or more second position factors for the second set of presentation positions.

17. The system of claim 15, wherein determining a reserve price for each particular presentation position in the first content item configuration comprises:
determining a value of a first particular presentation position based on a bid associated with a content item selected for presentation in the first particular presentation position and the position factor for the first particular presentation position;
determining a ratio of the value of the first particular presentation position and the position factor for a second particular presentation position; and
determining the reserve price for the second presentation position based on the ratio and a maximum specified deviation from the higher expected configuration efficiency.

18. The system of claim 17, wherein determining a value of a first particular presentation position comprises determining the value of a first presentation position that is included in each of the first content item configuration and the second content item configuration.

19. The system of claim 15, wherein the instructions cause the one or more data processing apparatus to perform operations further comprising determining, for each particular presentation position in a third content item configuration, a reserve price based on an expected value of other presentation positions in the third content item configuration and the position factor for the particular presentation position.

20. The system of claim 19, wherein the instructions cause the one or more data processing apparatus to perform operations further comprising determining that a reserve price for a particular presentation position in the third content item configuration is not met by a bid associated with content items eligible for presentation in the third content item configuration, wherein the third content item configuration includes more presentation positions than the second content item configuration.
